(19) United States
(12) Patent Application Publication
(10) Pub. No.: US 2023/0311946 A1
(43) Pub. Date: Oct. 5, 2023

(54) LOCALIZATION TECHNIQUES FOR AUTONOMOUS DRIVING OPERATIONS

(71) Applicant: TuSimple, Inc., San Diego, CA (US)

(72) Inventors: Ali Reza ABBASPOUR, San Diego, CA (US); Navid Sarmadnia, San Diego, CA (US)

(21) Appl. No.: 18/174,200

(22) Filed: Feb. 24, 2023

Related U.S. Application Data
(60) Provisional application No. 63/362,334, filed on Mar. 31, 2022.

(51) Int. Cl. B60W 60/00; B60W 30/09; G06V 20/56

(52) U.S. Cl. CPC B60W 60/0015; B60W 30/09; G06V 20/56; B60W 2556/40; B60W 2556/45; B60W 2300/125; B60W 2420/42

(57) ABSTRACT

The disclosed technology enables an in-vehicle control computer located in a vehicle to perform localization techniques to control a driving related operation of the vehicle. An example method to control a vehicle includes determining, by a computer located in a vehicle, a first characteristic of a first object from an image obtained by a camera located on the vehicle while the vehicle is operated on a road; determining whether the first characteristic of the first object matches a second characteristic of a second object obtained from a high-definition map stored in the computer; and sending, in response to determining that the first characteristic of the first object does not match the second characteristic of the second object, instructions that cause the vehicle to steer along a first trajectory to a side of the road and to apply brakes.

### CROSS-REFERENCE TO RELATED APPLICATIONS

This application claims priority to and the benefit of U.S. Provisional Application No. 63/362,334, filed on Mar. 31, 2022. The aforementioned of which is incorporated by reference in its entirety.

### TECHNICAL FIELD

This document relates to systems, methods, and apparatus to perform localization for autonomous driving systems.

### BACKGROUND

Self-driving or autonomous vehicles can be autonomously controlled to navigate along a path to a destination. Autonomous driving generally requires sensors and processing systems that perceive the environment surrounding an autonomous vehicle and make decisions based on that perception to facilitate safe and reliable operation of the autonomous vehicle.

### SUMMARY

This patent document describes systems, apparatus, and methods to perform localization for autonomous vehicles. In some embodiments, an exemplary localization technique can incorporate a high-definition map based localization approach that can be enhanced with a resilient localization algorithm.

An example method for autonomous driving operation includes determining, by a computer located in a vehicle, a first characteristic of a first object from an image obtained by a camera located on the vehicle while the vehicle is operated on a road; determining whether the first characteristic of the first object matches a second characteristic of a second object obtained from a high-definition map stored in the computer, where the second object is located in an area that is within a field-of-view of the camera when the camera obtained the image; and sending, in response to determining that the first characteristic of the first object does not match the second characteristic of the second object, instructions that cause the vehicle to steer along a first trajectory to a side of the road and to apply brakes.

In some embodiments, the first characteristic of the first object is determined to not match the second characteristic of the second object by: determining that the first characteristic is associated with a first value that is outside of a first pre-determined range of the second value of the second characteristic of the second object. In some embodiments, the method further comprises determining, in response to determining that the first characteristic of the first object does not match the second characteristic of the second object, whether a signal strength of a signal received by a global navigation satellite system (GNSS) device (e.g., GNSS receiver) located on the vehicle is less than a threshold value for more than a pre-determined time period; where the sending the instructions is in response to: determining that the first characteristic of the first object does not match the second characteristic of the second object, and determining that the signal strength of the signal is less than the threshold value for more than the pre-determined time period.

In some embodiments, the method further comprises determining, in response to determining that the signal strength of the signal is greater than or equal to the threshold value for more than the pre-determined time period, whether a first altitude obtained from a sensor located on the vehicle matches a second altitude obtained from the high-definition map and corresponding to a location of the vehicle; and sending, in response to determining that the first altitude does not match the second altitude, instructions that cause the vehicle to steer along a second trajectory to the side of the road and to apply brakes. In some embodiments, the first altitude is determined to not match the second altitude by: determining that the first altitude is outside of a second pre-determined range of the second altitude. In some embodiments, the method further comprises performing a determination that the first altitude is within a second pre-determined range of the second altitude; and causing, in response to the determination, the vehicle to operate on the road using location information provided by the global navigation satellite system device. In some embodiments, the sensor includes a barometer.

In some embodiments, the method further comprises in response to determining that the signal strength of the signal is greater than or equal to the threshold value for more than the pre-determined time period: performing a determination that a first altitude obtained from a sensor located on the vehicle is within a second pre-determined range of a second altitude obtained from the high-definition map and corresponding to a location of the vehicle; and causing, in response to the determination, the vehicle to operate along a planned trajectory using location information obtained from a global navigation satellite system device located on the vehicle. In some embodiments, the method further comprises performing a determination that the first characteristic of the first object matches the second characteristic of the second object; causing, in response to the determination, the vehicle to be driven along a planned trajectory on the road. In some embodiments, the first characteristic of the first object is determined to match the second characteristic of the second object by: determining that the first characteristic is associated with a first value that is within a first pre-determined range of the second value of the second characteristic of the second object.

In some embodiments, the planned trajectory is different than the first trajectory. In some embodiments, the method further comprises determining that a second image of second area obtained from the camera does not include a third object obtained from the high-definition map, where the third object is located in the second area that is within a field-of-view of the camera when the camera obtained the second image; determining, in response to determining that the second image does not include the third object, whether a signal strength of a second signal received by a global navigation satellite system device is less than a threshold value for more than the pre-determined time period; and sending, in response to determining that the signal strength of the second signal is less than the threshold value for more than the pre-determined time period, instructions that cause the vehicle to steer along the first trajectory to the side of the road and to apply brakes.

In some embodiments, the method further comprises determining a presence of a weather condition in an area where the vehicle is operating in response to determining that the second image does not include the third object from the high-definition map. In some embodiments, the high-definition map stored in the computer is periodically updated. In some embodiments, the second object is obtained from the high-definition map using a location of the vehicle obtained from a global navigation satellite system device located on the vehicle, wherein the location of the vehicle is associated with a time when the image is obtained from the camera. In some embodiments, the first characteristic includes a first location of the first object, and wherein the second characteristic includes a second location of the second object. In some embodiments, the first object and the second object include a traffic light, a traffic sign, a bridge, or an object on the road. In some embodiments, the vehicle includes a semi-trailer truck.

In yet another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed. In yet another exemplary embodiment, a system comprises a computer located in a vehicle, the computer comprises a processor configured to implement the above-described methods is disclosed.

The above and other aspects and their implementations are described in greater detail in the drawings, the descriptions, and the claims.

### BRIEF DESCRIPTION OF THE DRAWINGS

FIG. 1 illustrates a block diagram of an example vehicle ecosystem of an autonomous vehicle.

FIG. 2 shows a flowchart of an example localization technique.

FIG. 3 shows an example flowchart for perform driving related operation of an autonomous vehicle with an example localization technique.

### DETAILED DESCRIPTION

Autonomous driving operations can be performed by at least determining a location of an autonomous vehicle (also known as localization) on earth. An autonomous vehicle can perform localization by using information (e.g., latitude, longitude, etc.) provided by a global navigation satellite system (GNSS) device (e.g., GNSS receiver) onboard the autonomous vehicle. Such a technique can be referred to as GNSS-based localization. However, in some situations, the GNSS device (e.g., a GNSS receiver) may be subject to GNSS spoofing such as when a hacker transmits wrong GNSS related information that is received by the GNSS device.

Autonomous driving operations can also be performed by least using a high-definition (HD) map that provides information about a road and/or area where the autonomous vehicle is operating. Such a technique can be referred to as HD map-based localization at least because the HD map can provide location information of one or more objects (e.g., traffic signs, traffic lights, coordinates of a lane, etc.) in an area where the autonomous vehicle is operating. The HD map can be stored in a computer onboard the autonomous vehicle. An example autonomous driving operation can include determining a traffic signal from an image obtained by the camera and determining the location of the traffic signal from the HD map that can include such information. However, in some situations, an autonomous vehicle may also be subject to sensor data spoofing such as camera spoofing which can happen when the camera onboard the autonomous vehicle obtains an image that indicates a presence of a traffic sign that is not indicated in a HD map. For example, if a car driving in front of an autonomous vehicle includes an unofficial or fake traffic stop sign on a rear bumper or trunk of the car, then the computer located in the autonomous vehicle could be spoofed to perform autonomous driving operations (e.g., send instructions to apply brakes) in response to determining a presence of the unofficial or fake traffic stop sign.

This patent document first describes in Section I an example vehicle ecosystem of an autonomous vehicle, and then describes in Section II example techniques for performing localization in an autonomous vehicle. The example headings for the various sections below are used to facilitate the understanding of the disclosed subject matter and do not limit the scope of the claimed subject matter in any way. Accordingly, one or more features of one example section can be combined with one or more features of another example section.

I. Example Ecosystem of an Autonomous Vehicle

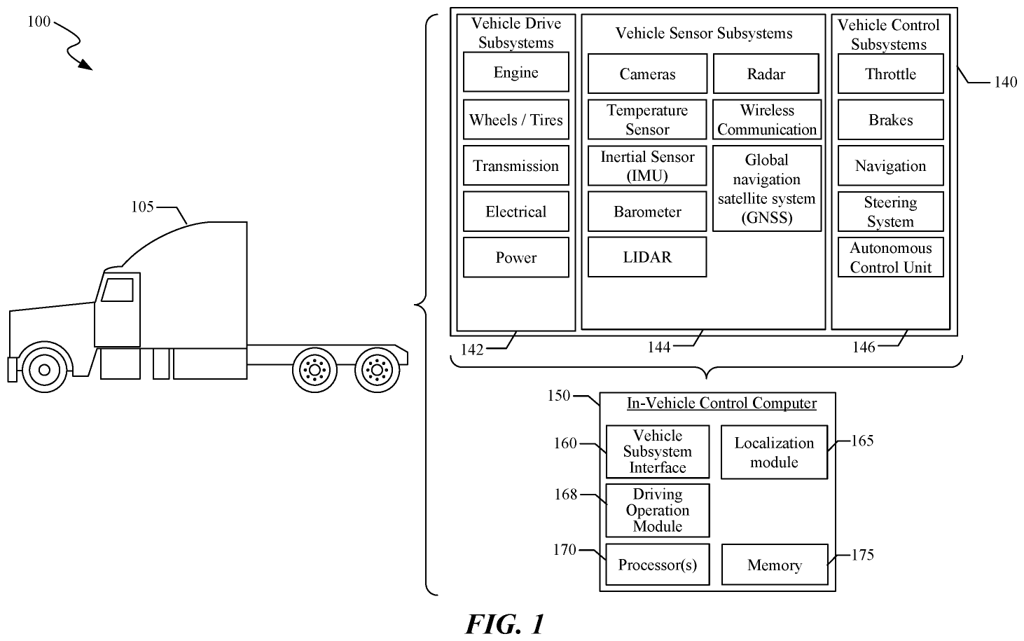

FIG. 1 illustrates a block diagram of an example vehicle ecosystem of an autonomous vehicle. The system 100 includes an autonomous vehicle 105, such as a tractor unit of a semi-trailer truck. The autonomous vehicle 105 may include a plurality of vehicle subsystems 140 and an in-vehicle control computer 150. The plurality of vehicle subsystems 140 can include, for example, vehicle drive subsystems 142, vehicle sensor subsystems 144, and vehicle control subsystems 146. FIG. 1 shows several devices or systems being associated with the autonomous vehicle 105. In some embodiments, additional devices or systems may be added to the autonomous vehicle 105, and in some embodiments, some of the devices or systems show in FIG. 1 may be removed from the autonomous vehicle 105.

An engine, wheels and tires, a transmission, an electrical subsystem, and a power subsystem may be included in the vehicle drive subsystems 142. The engine of the autonomous truck may be an internal combustion engine (or gas-powered engine), a fuel-cell powered electric engine, a battery powered electric engine/motor, a hybrid engine, or another type of engine capable of actuating the wheels on which the autonomous vehicle 105 (also referred to as vehicle 105 or truck 105) moves. The autonomous vehicle 105 can have multiple engines to drive its wheels. For example, the vehicle drive subsystems 142 can include two or more electrically driven motors. The transmission of the vehicle 105 may include a continuous variable transmission or a set number of gears that translate power created by the engine of the vehicle 105 into a force that drives the wheels of the vehicle 105. The vehicle drive subsystems 142 may include an electrical system that monitors and controls the distribution of electrical current to components within the vehicle drive subsystems 142 (and/or within the vehicle subsystems 140), including pumps, fans, and actuators. The power subsystem of the vehicle drive subsystems 142 may include components which regulate a power source of the vehicle 105.

Vehicle sensor subsystems 144 can include sensors which are used to support general operation of the autonomous truck 105. The sensors for general operation of the autonomous vehicle may include, for example, one or more cameras, a temperature sensor, an inertial sensor, a global navigation satellite system (GNSS) device (e.g., GNSS receiver), a barometer sensor, a LiDAR system, a radar system, and/or a wireless communications system. In some embodiments, GNSS may be used with or replaced with global navigation satellite system (GLONASS), a BeiDou Navigation System (BDS), a Quasi-Zenith Satellite System (QZSS), or an Indian Regional Navigation Satellite System (IRNSS).

The vehicle control subsystems 146 may include various elements, devices, or systems including, e.g., a throttle, a brake unit, a navigation unit, a steering system, and an autonomous control unit. The vehicle control subsystems 146 may be configured to control operation of the autonomous vehicle, or truck, 105 as a whole and operation of its various components. The throttle may be coupled to an accelerator pedal so that a position of the accelerator pedal can correspond to an amount of fuel or air that can enter the internal combustion engine. The accelerator pedal may include a position sensor that can sense a position of the accelerator pedal. The position sensor can output position values that indicate the positions of the accelerator pedal (e.g., indicating the amounts by which the accelerator pedal is depressed or that the accelerator pedal is undepressed). The brake unit can include any combination of mechanisms configured to decelerate the autonomous vehicle 105. The brake unit can use friction to slow the wheels of the vehicle in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically based on, e.g., traffic or road conditions, while, e.g., the autonomous vehicle 105 is in operation. In some embodiments, the navigation unit may be configured to incorporate data from a GNSS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode of the vehicle operation.

The autonomous control unit may include a control system (e.g., a computer or controller comprising a processor) configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some example embodiments, the autonomous control unit may be configured to incorporate data from the GNSS device, the radar, the LiDAR, the cameras, and/or other vehicle sensors and subsystems to determine the driving path or trajectory for the autonomous vehicle 105.

An in-vehicle control computer 150, which may be referred to as a vehicle control unit or VCU, can include, for example, any one or more of: a vehicle subsystem interface 160, a localization module 165, a driving operation module 168, one or more processors 170, and/or a memory 175. This in-vehicle control computer 150 may control many, if not all, of the operations of the autonomous truck 105 in response to information from the various vehicle subsystems 140. The memory 175 may contain processing instructions (e.g., program logic) executable by the processor(s) 170 to perform various methods and/or functions of the autonomous vehicle 105, including those described in this patent document. For instance, the data processor 170 executes the operations associated with vehicle subsystem interface 160 and/or localization module 165. The in-vehicle control computer 150 can control one or more elements, devices, or systems in the vehicle drive subsystems 142, vehicle sensor subsystems 144, and/or vehicle control subsystems 146. For example, the localization module 165 in the in-vehicle control computer 150 may determine the location of the autonomous vehicle 105 and/or a direction (or trajectory) in which the autonomous vehicle 105 should operate to enable the autonomous vehicle 105 to be driven in an autonomous mode.

The memory 175 may include instructions to transmit data to, receive data from, interact with, or control one or more of the vehicle drive subsystems 142, vehicle sensor subsystems 144, or vehicle control subsystems 146. The in-vehicle control computer (VCU) 150 may control the operation of the autonomous vehicle 105 based on inputs received by the VCU from various vehicle subsystems (e.g., the vehicle drive subsystems 142, the vehicle sensor subsystems 144, and the vehicle control subsystems 146). The VCU 150 may, for example, send information (e.g., commands, instructions or data) to the vehicle control subsystems 146 to direct or control functions, operations or behavior of the autonomous vehicle 105 including, e.g., its trajectory, velocity, and signaling behaviors. The vehicle control subsystems 146 may receive a course of action to be taken from one or more modules of the VCU 150 and may, in turn, relay instructions to other subsystems to execute the course of action.

II. Techniques to Perform Localization in an Autonomous Vehicle

In this Section, techniques are described for an in-vehicle control computer 150 located in an autonomous vehicle 105 to perform localization for performing autonomous driving operation(s).

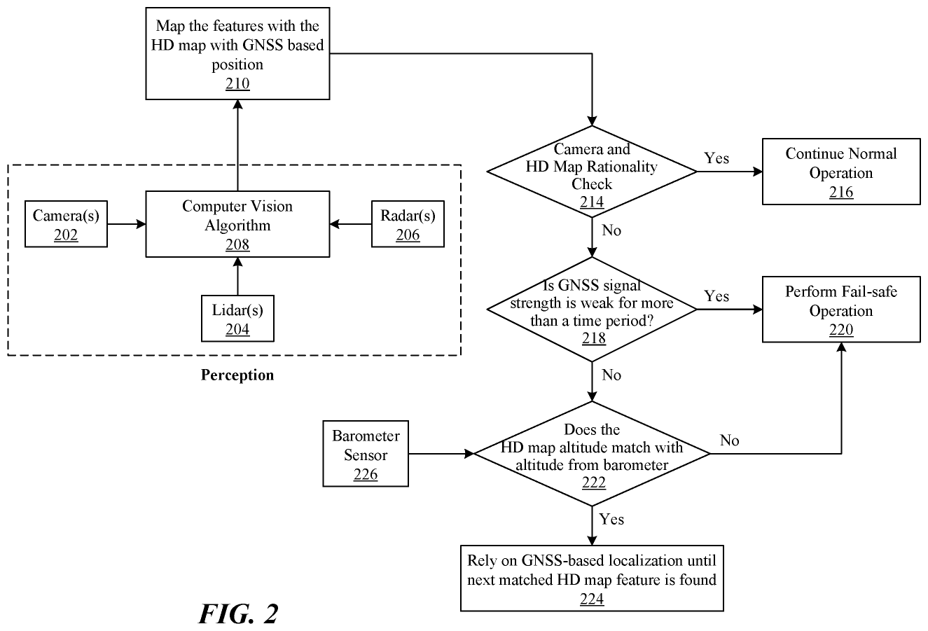

FIG. 2 shows a flowchart of an example localization technique. At operation 208, the driving operation module (shown as 168 in FIG. 1) receives sensor data from one or more cameras 202, one or more LiDARs 204 and/or one or more Radars 206 on an autonomous vehicle to perform the computer vision algorithm. For example, at operation 208, the driving operation module can receive an image from the camera and determine objects (e.g., road sign, other vehicle(s)) that are located in a region where the autonomous vehicle is operating. At operation 208, the driving module can also obtain LiDAR and Radar point cloud data to determine characteristics (e.g., distance from autonomous vehicle, speed, etc.) of the object determined from the image obtained from the camera.

At operation 210, the driving operation module can use a GNSS based position and/or orientation of the autonomous vehicle and the HD map stored in the in-vehicle control computer to map one or more objects identified or determined from the sensor data to one or more previously stored objects in the HD map. At operation 210, the driving operation module can obtain a GNSS position and/or orientation of the autonomous vehicle from a GNSS device on or in the autonomous vehicle and can use that GNSS position to determine one or more objects that should be present in that region from the HD map. The GNSS position can be associated with a time when the sensor data (e.g., image from the camera) is obtained at operation 208. For example, the driving operation module can determine that a traffic sign is present in an image obtained from a front-facing camera on the autonomous vehicle, and the driving operation module can determine a presence of a traffic sign that is previously stored in the HD map by searching the HD map for traffic signs in a direction in which the autonomous vehicle is traveling (or orientation) and/or within a distance from the GNSS position of the autonomous vehicle. In this example, the GNSS position can be associated with a time when the image is obtained from the front-facing camera. Thus, an object that is obtained from an HD map is located in an area within a field-of-view of the camera that obtained the image. The driving operation module can obtain the direction in which the autonomous vehicle is traveling from the inertial sensor and/or the GNSS device. In the above example, the driving operation module can determine the position or location of the traffic sign from the HD map that can store such information about objects on the road.

At operation 214, the localization module can perform a rationality check by comparing the characteristics of one or more objects determined or identified from an image of the camera with characteristics of the one or more objects from the HD map. The localization module can use a GNSS based position of the autonomous vehicle and/or direction in which the autonomous vehicle is operating to obtain the characteristics of the one or more objects from the HD map. Once the localization module obtains the characteristics of one or more objects from the HD map, the localization module can determine the extent to which those characteristics match the characteristics determined from an image of the camera.

For example, at operation 208, the driving operation module can determine a presence of a bridge on a road on which the autonomous vehicle is traveling from an image of a camera and can also determine a height from the road to the bottom region of the bridge. In this example, at operation 214, the localization module can determine whether the height of the bridge is within a pre-determined range of a height of the bridge stored in the HD map. In another example, the localization module can determine whether a location of the traffic light (determined by the driving operation module from an image obtained from the camera) is within a pre-determined range of a location of the traffic light stored in the HD map. In yet another example, at operation 214, the localization module can determine whether a traffic sign determined from an image of a forward-facing camera is also present in the HD map in a direction in which the autonomous vehicle is operating or driving.

At operation 214, if the localization module determines that one or more characteristics of an object determined from the image of a camera match one or more characteristics of the same object in the HD map (e.g., if the location of a traffic sign determined from the image is within a pre-determined range of the location of the traffic sign in the HD map), then the localization module can determine to let the autonomous driving operation continue at operation 216. At operation 216, the localization module can let the autonomous vehicle to be driven along a determined or planned trajectory on the road without intervening to cause a deviation from the determined or planned trajectory along the road. At operation 216, the driving operation module can send instructions to one or more devices (e.g., motor(s) in the steering system, engine, brakes, transmission, etc.) to cause the autonomous vehicle to be driven along the determined or planned trajectory.

At operation 214, if the localization module determines that at least one characteristic of an object determined from the image of a camera does not match at least one characteristic of the same object in the HD map (e.g., if a value of a characteristic of an object determined from the image is outside of a pre-determined range of the value of the characteristic of the object obtained from the HD map), then the localization module can proceed to operation 218. If the localization module determines that the characteristic(s) from the image do not match the characteristic(s) from the HD map, then the localization module can determine that the image obtained by the camera may be spoofed (e.g., the image may include an unofficial or fake traffic sign). Thus, one of the benefits of the exemplary localization techniques is that it can be resilient against sensor data spoofing. In some embodiments, at operation 214, the localization module can perform rationality check by determining whether the HD map indicates a presence of an object that is not found in an image obtained by the camera. In such embodiment, if the localization module determines that an image from the camera does not include an object that is present in an area as indicated by the HD map, then the localization module can proceed to operation 218.

At operation 218, the localization module can determine whether the GNSS signal received by the GNSS device is weak for more than a time period (e.g., a pre-determined time period). The GNSS device can provide to the localization module a value that indicates signal strength of the GNSS signal received by the GNSS device. At operation 218, if the localization module determines that the value that indicates signal strength of the GNSS signal is less than a pre-determined threshold for more than a certain time period (e.g., pre-determined time period), then the localization module can proceed to operation 220 where the localization module can intervene in the autonomous driving operation of the autonomous vehicle to cause the autonomous vehicle to perform a fail-safe operation at operation 220.

At operation 220, the localization module can trigger a fail-safe operation by sending instructions to the driving operation module to cause the autonomous vehicle to deviate from its planned trajectory and to use a fail-safe trajectory that causes the autonomous vehicle to pull over and stop along the side of the road. The fail-safe trajectory can be different from the planned trajectory and can be determined by the driving operation module at a certain pre-determined frequency (e.g., every two seconds) so that the autonomous vehicle can be pulled over and stopped along the side of a road in case the driving operation module determines a presence of a failure (e.g., determines that cameras stop working or receive error message from the engine) or in case the driving operation module receives an message from the localization module that indicates that the value that indicates signal strength of the GNSS signal is less than a pre-determined threshold for more than a certain time period (as mentioned in operation 218). At operation 220, the driving operation module can send one or more instructions to the steering system, engine and/or brakes to steer the autonomous vehicle to pull over and/or stop the autonomous vehicle along the side of the road. At operation 220, the driving operation module can use the sensor data obtained from the camera(s) to avoid objects on the road and/or IMU to safely pull over the autonomous vehicle along the side of the road. The IMU can provide to the driving operation module information such as angular rate(s), forces or acceleration applied to or experienced by the autonomous vehicle, orientation, etc.

At operation 218, if the localization module determines that the value that indicates signal strength of the GNSS signal is greater than or equal to a pre-determined threshold for more than a certain time period (e.g., pre-determined time period), then the localization module can proceed to operation 222 where the localization module can determine whether an altitude corresponding to the location of the autonomous vehicle and obtained from the HD map matches the altitude provided by a barometer sensor 226 located on the autonomous vehicle. If the localization module determines that the altitude from the barometer sensor 226 is outside of a second pre-determined range of the altitude obtained from the HD map, then the localization module can proceed to operation 220 where the autonomous vehicle can be driven to a fail-safe trajectory that causes the autonomous vehicle to pull over and stop along the side of the road.

In some embodiments, the fail-safe trajectory on which the autonomous vehicle is operated after operation 222 can be the same as the fail-safe trajectory after operation 218 when, for example, operations 218 and 222 are performed at two time values that are located in time after a first time value when the fail-safe trajectory is determined but before a second time value when an updated fail-safe trajectory is determined. In some embodiments, the fail-safe trajectory on which the autonomous vehicle is operated after operation 222 can be different than the fail-safe trajectory after operation 218 when, for example, operation 218 are performed at a first time that is located in time after a first time value when the fail-safe trajectory is determined, and when operation 222 is performed at a second time value when an updated fail safe trajectory is determined.

If the localization module determines that the altitude from the HD map is within the pre-determined range of the altitude obtained from the barometer sensor 226, then the localization module can proceed to operation 224. At operation 224, the localization module can send to the driving operation module the location information (e.g., GNSS coordinates) provided by the GNSS device over time to cause the driving operation module to use the provided location information to operate the autonomous vehicle along a determined or planned trajectory along a road over time. Thus, at operation 224, the localization module can cause the driving operation module to use a GNSS-based localization technique until the localization module determines that a next characteristic of another object on a road (determined from another image obtained by the camera) matches a corresponding characteristic of a related object from the HD map by using the techniques described in operation 214. In some embodiments, at operation 224, the localization module may send, to the driving operation module, the location information provided by the GNSS device and the localization module can perform the operation(s) described for operation 214 and proceed with any one or more of operations 216 to 224 as described in this patent document.

One of the benefits of the exemplary localization techniques is that it can provide higher accuracy than using GNSS based on HD map-based localization techniques. In some embodiments, the exemplary localization techniques can incorporate the advantages of HD map-based localization and GNSS-based localization (which can happen at the same time), determine which type of localization (e.g., HD map-based localization or GNSS-based localization) provides higher precision as explained in operation 214 and determine GNSS signal strength as explained in operation 218. In some embodiments, the exemplary localization techniques can switch between one of two localization techniques (GNSS-based and HD map-based) when one fails to give an accurate position. In some embodiments, the exemplary localization techniques can trigger the autonomous vehicle to perform a fail-safe operation (as explained in operation 220) when the GNSS-based localization is determined to fail or not operate properly or when the GNSS-based and HD-map based localization is determined to fail or not operate properly.

In some embodiments, the driving operation module can periodically update the HD map stored in the in-vehicle control computer so that the exemplary localization techniques can increase resiliency against outdated HD maps. In an example implementation, the driving operation module can download a latest version of the HD map in response to determining that a version of the HD map stored in the in-vehicle control computer is not the latest version of the HD map available. The process of periodically updating the HD map can beneficially allow the localization module to more accurately determine whether a characteristic of an object identified in a camera image matches a characteristic of an object from the HD map.

In some embodiments, the exemplary localization techniques can improve resiliency against harsh weather condition. For example, if the localization module determines that the HD map indicates a presence of an object that is not found in an image obtained by the camera (e.g., in operation 214 in FIG. 2), then the localization module can determine that a harsh weather condition may have prevented the camera from obtaining an image that includes the object. In this example, if the localization module determines that an object in the HD map associated with the location of the autonomous vehicle is not found in the image related to that location, then the localization module can perform operations in FIG. 2 starting at operation 218 as described in this patent document. Thus, one of the benefits of the localization techniques described in this patent document is that it can allow the autonomous vehicle to use a GNSS-based localization technique in a harsh weather condition that can affect one or more images obtained by one or more cameras on the autonomous vehicle so that the autonomous vehicle can continue to be operated in a harsh weather condition.

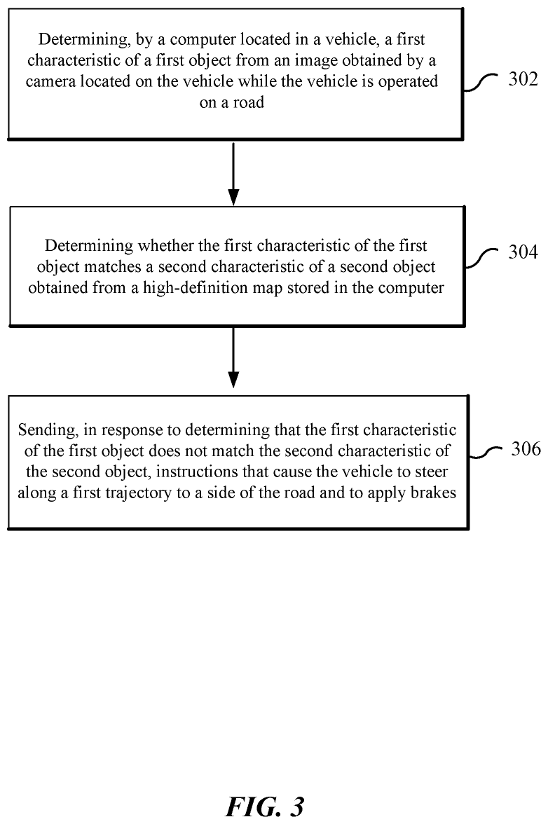

FIG. 3 shows an example flowchart for perform driving related operation of an autonomous vehicle with an example localization technique. Operation 302 includes determining, by a computer located in a vehicle, a first characteristic of a first object from an image obtained by a camera located on the vehicle while the vehicle is operated on a road. Operation 304 includes determining whether the first characteristic of the first object matches a second characteristic of a second object obtained from a high-definition map stored in the computer, where the second object is located in an area that is within a field-of-view of the camera when the camera obtained the image. Operation 306 includes sending, in response to determining that the first characteristic of the first object does not match the second characteristic of the second object, instructions that cause the vehicle to steer along a first trajectory to a side of the road and to apply brakes.

In some embodiments, the first characteristic of the first object is determined to not match the second characteristic of the second object by: determining that the first characteristic is associated with a first value that is outside of a first pre-determined range of the second value of the second characteristic of the second object. In some embodiments, the method further comprises determining, in response to determining that the first characteristic of the first object does not match the second characteristic of the second object, whether a signal strength of a signal received by a global navigation satellite system device located on the vehicle is less than a threshold value for more than a pre-determined time period; where the sending the instructions is in response to: determining that the first characteristic of the first object does not match the second characteristic of the second object, and determining that the signal strength of the signal is less than the threshold value for more than the pre-determined time period.

In some embodiments, the method further comprises determining, in response to determining that the signal strength of the signal is greater than or equal to the threshold value for more than the pre-determined time period, whether a first altitude obtained from a sensor located on the vehicle matches a second altitude obtained from the high-definition map and corresponding to a location of the vehicle; and sending, in response to determining that the first altitude does not match the second altitude, instructions that cause the vehicle to steer along a second trajectory to the side of the road and to apply brakes. In some embodiments, the first altitude is determined to not match the second altitude by: determining that the first altitude is outside of a second pre-determined range of the second altitude. In some embodiments, the method further comprises performing a determination that the first altitude is within a second pre-determined range of the second altitude; and causing, in response to the determination, the vehicle to operate on the road using location information provided by the global navigation satellite system device. In some embodiments, the sensor includes a barometer.

In some embodiments, the method further comprises in response to determining that the signal strength of the signal is greater than or equal to the threshold value for more than the pre-determined time period: performing a determination that a first altitude obtained from a sensor located on the vehicle is within a second pre-determined range of a second altitude obtained from the high-definition map and corresponding to a location of the vehicle; and causing, in response to the determination, the vehicle to operate along a planned trajectory using location information obtained from a global navigation satellite system device located on the vehicle. In some embodiments, the method further comprises performing a determination that the first characteristic of the first object matches the second characteristic of the second object; causing, in response to the determination, the vehicle to be driven along a planned trajectory on the road. In some embodiments, the first characteristic of the first object is determined to match the second characteristic of the second object by: determining that the first characteristic is associated with a first value that is within a first pre-determined range of the second value of the second characteristic of the second object.

In some embodiments, the planned trajectory is different than the first trajectory. In some embodiments, the method further comprises determining that a second image of second area obtained from the camera does not include a third object obtained from the high-definition map, where the third object is located in the second area that is within a field-of-view of the camera when the camera obtained the second image; determining, in response to determining that the second image does not include the third object, whether a signal strength of a second signal received by a global navigation satellite system device is less than a threshold value for more than the pre-determined time period; and sending, in response to determining that the signal strength of the second signal is less than the threshold value for more than the pre-determined time period, instructions that cause the vehicle to steer along the first trajectory to the side of the road and to apply brakes.

In some embodiments, the method further comprises determining a presence of a weather condition in an area where the vehicle is operating in response to determining that the second image does not include the third object from the high-definition map. In some embodiments, the high-definition map stored in the computer is periodically updated. In some embodiments, the second object is obtained from the high-definition map using a location of the vehicle obtained from a global navigation satellite system device located on the vehicle, wherein the location of the vehicle is associated with a time when the image is obtained from the camera. In some embodiments, the first characteristic includes a first location of the first object, and wherein the second characteristic includes a second location of the second object. In some embodiments, the first object and the second object include a traffic light, a traffic sign, a bridge, or an object on the road. In some embodiments, the vehicle includes a semi-trailer truck.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In this disclosure, LiDAR or LIDAR are used to refer to light detection and ranging devices and methods, and alternatively, or additionally, laser detection and ranging devices and methods. The use of these acronyms does not imply limitation of the described devices, systems, or methods to the use of one over the other.

While this patent document contains many specifics, these should not be construed as limitations on the scope of any invention or of what may be claimed, but rather as descriptions of characteristics that may be specific to particular embodiments of particular inventions. Certain characteristics that are described in this patent document in the context of separate embodiments can also be implemented in combination in a single embodiment. Conversely, various characteristics that are described in the context of a single embodiment can also be implemented in multiple embodiments separately or in any suitable sub combination. Moreover, although characteristics may be described above as acting in certain combinations and even initially claimed as such, one or more characteristics from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of autonomous driving operation, comprising:
determining, by a computer located in a vehicle, a first characteristic of a first object from an image obtained by a camera located on the vehicle while the vehicle is operated on a road;
determining whether the first characteristic of the first object matches a second characteristic of a second object obtained from a high-definition map stored in the computer,
wherein the second object is located in an area that is within a field-of-view of the camera when the camera obtained the image; and
sending, in response to determining that the first characteristic of the first object does not match the second characteristic of the second object, instructions that cause the vehicle to steer along a first trajectory to a side of the road and to apply brakes.

2. The method of claim 1, wherein the first characteristic of the first object is determined to not match the second characteristic of the second object by:
determining that the first characteristic is associated with a first value that is outside of a first pre-determined range of a second value of the second characteristic of the second object.

3. The method of claim 1, further comprising:
determining, in response to determining that the first characteristic of the first object does not match the second characteristic of the second object, whether a signal strength of a signal received by a global navigation satellite system device located on the vehicle is less than a threshold value for more than a pre-determined time period;
wherein the sending the instructions is in response to:
determining that the first characteristic of the first object does not match the second characteristic of the second object, and
determining that the signal strength of the signal is less than the threshold value for more than the pre-determined time period.

4. The method of claim 1, further comprising:
determining, in response to determining that a signal strength of a signal received by a global navigation satellite system device located on the vehicle is greater than or equal to a threshold value for more than a pre-determined time period, whether a first altitude obtained from a sensor located on the vehicle matches a second altitude obtained from the high-definition map and corresponding to a location of the vehicle; and
sending, in response to determining that the first altitude does not match the second altitude, instructions that cause the vehicle to steer along a second trajectory to the side of the road and to apply brakes.

5. The method of claim 4, wherein the first altitude is determined to not match the second altitude by:
determining that the first altitude is outside of a second pre-determined range of the second altitude.

6. The method of claim 4, further comprising:
performing a determination that the first altitude is within a second pre-determined range of the second altitude; and
causing, in response to the determination, the vehicle to operate on the road using location information provided by the global navigation satellite system device.

7. The method of claim 4, wherein the sensor includes a barometer.

8. The method of claim 1, further comprising:
in response to determining that a signal strength of a signal received by a global navigation satellite system device located on the vehicle is greater than or equal to a threshold value for more than a pre-determined time period:
performing a determination that a first altitude obtained from a sensor located on the vehicle is within a second pre-determined range of a second altitude obtained from the high-definition map and corresponding to a location of the vehicle; and
causing, in response to the determination, the vehicle to operate along a planned trajectory using location information obtained from the global navigation satellite system device.

9. A non-transitory computer readable program storage medium having code stored thereon, the code, when executed by a processor, causing the processor to perform operations comprising:
determining, by a computer located in a vehicle, a first characteristic of a first object from an image obtained by a camera located on the vehicle while the vehicle is operated on a road;
determining whether the first characteristic of the first object matches a second characteristic of a second object obtained from a high-definition map stored in the computer,
wherein the second object is located in an area that is within a field-of-view of the camera when the camera obtained the image; and
sending, in response to determining that the first characteristic of the first object does not match the second characteristic of the second object, instructions that cause the vehicle to steer along a first trajectory to a side of the road and to apply brakes.

10. The non-transitory computer readable program storage medium of claim 9, wherein the operations comprise:
performing a determination that the first characteristic of the first object matches the second characteristic of the second object;
causing, in response to the determination, the vehicle to be driven along a planned trajectory on the road.

11. The non-transitory computer readable program storage medium of claim 10, wherein the first characteristic of the first object is determined to match the second characteristic of the second object by:
determining that the first characteristic is associated with a first value that is within a first pre-determined range of a second value of the second characteristic of the second object.

12. The non-transitory computer readable program storage medium of claim 10, wherein the planned trajectory is different than the first trajectory.

13. The non-transitory computer readable program storage medium of claim 9, wherein the operations further comprise:
determining that a second image of second area obtained from the camera does not include a third object obtained from the high-definition map,
wherein the third object is located in the second area that is within a field-of-view of the camera when the camera obtained the second image;
determining, in response to determining that the second image does not include the third object, whether a signal strength of a second signal received by a global navigation satellite system device is less than a threshold value for more than a pre-determined time period; and
sending, in response to determining that the signal strength of the second signal is less than the threshold value for more than the pre-determined time period, instructions that cause the vehicle to steer along the first trajectory to the side of the road and to apply brakes.

14. The non-transitory computer readable program storage medium of claim 13, wherein the operations further comprise:
determining a presence of a weather condition where the vehicle is operating in response to determining that the second image does not include the third object from the high-definition map.

15. A system comprising a computer located in a vehicle, the computer comprising a processor configured to implement a method, the processor configured to:
determine a first characteristic of a first object from an image obtained by a camera located on the vehicle while the vehicle is operated on a road;
determine whether the first characteristic of the first object matches a second characteristic of a second object obtained from a high-definition map stored in the computer,
wherein the second object is located in an area that is within a field-of-view of the camera when the camera obtained the image; and
send, in response to a determination that the first characteristic of the first object does not match the second characteristic of the second object, instructions that cause the vehicle to steer along a first trajectory to a side of the road and to apply brakes.

16. The system of claim 15, wherein the high-definition map stored in the computer is periodically updated.

17. The system of claim 15, wherein the second object is obtained from the high-definition map using a location of the vehicle obtained from a global navigation satellite system device located on the vehicle, wherein the location of the vehicle is associated with a time when the image is obtained from the camera.

18. The system of claim 15, wherein the first characteristic includes a first location of the first object, and wherein the second characteristic includes a second location of the second object.

19. The system of claim 15, wherein the first object and the second object include a traffic light, a traffic sign, a bridge, or an object on the road.

20. The system of claim 15, wherein the vehicle includes a semi-trailer truck.
